(19) United States
(12) Patent Application Publication
(10) Pub. No.: US 2009/0147185 A1
(43) Pub. Date: Jun. 11, 2009

(54) Reflective One-Way Screen with Chromatic and Transparent Regions

(75) Inventor: Cang V. Quach, Milpitas, CA (US)

Correspondence Address: PATENT LAW GROUP LLP, 2635 NORTH FIRST STREET, SUITE 223, SAN JOSE, CA, 95134, US

(73) Assignee: EMISCAPE, INC., San Francisco, CA (US)

(21) Appl. No.: 11/951,183

(22) Filed: Dec. 5, 2007

(51) Int. Cl. G02F 1/1335; G02F 1/1333

(52) U.S. Cl. 349/69; 349/89

(57) ABSTRACT

A one-way display system has a display layer with opaque active pixels and transparent inactive pixels interspersed with the active pixels. Each active pixel has a chromatic side and an opaque side. The active pixels is able to form an image visible from a first side of the display layer but not from a second side of the display layer, and the inactive pixels allows objects on the first side of the display layer to be seen from the second side of the display layer.

### CROSS REFERENCE TO RELATED APPLICATION

This application is related to (1) U.S. patent application Ser. No. 11/109,543, entitled “Polarized Projection Display,” filed on Apr. 18, 2005, (2) U.S. patent application Ser. No. 11/686,195, entitled “Polarized Projection Display,” filed on Mar. 14, 2007, (3) U.S. patent application Ser. No. 11/367,687, entitled “One-Way Transparent Display Systems,” filed on Mar. 3, 2006, and (4) U.S. patent application Ser. No. 11/626,247, entitled “Projection Display with Holographic Screen,” filed on Jan. 23, 2007, and (5) U.S. patent application Ser. No. 11/782,597, entitled “One-Way Display Using Color Filter,” filed on Jul. 24, 2007, which are incorporated herein by reference.

### FIELD OF INVENTION

This invention relates to displays, and specifically to transparent displays with an image that is visible from one side of the display but not the other.

### DESCRIPTION OF RELATED ART

Electronic ink is a material that is processed into a film for integration into electronic displays. The principal components of electronic ink are millions of tiny microcapsules, about the diameter of a human hair. In one incarnation, each microcapsule contains positively charged white particles and negatively charged black particles suspended in a clear fluid. When a negative electric field is applied, the white particles move to the top of the microcapsule where they become visible to the user. This makes the surface appear white at that spot. At the same time, an opposite electric field pulls the black particles to the bottom of the microcapsules where they are hidden. By reversing this process, the black particles appear at the top of the capsule, which now makes the surface appear dark at that spot.

To form an electronic ink electronic display, the ink is printed onto a sheet of plastic film that is laminated to a layer of circuitry. The circuitry forms a pattern of pixels that can then be controlled by a display driver. These microcapsules are suspended in a liquid “carrier medium” allowing them to be printed using existing screen printing processes onto virtually any surface, including glass, plastic, fabric, and even paper.

One-way vision film is a window-graphics media for outdoor advertising, including vehicle and building wraps, point of purchase, retail and commercial window signage, corporate identity, and more. Typically the one-way vision film is perforated and has an opaque light-reflective surface with an image and a light-absorbing surface. The image is clearly visible when viewing the film from one direction and the perforation permits substantially unobstructed through-viewing when viewing the film from a second, opposite direction.

### SUMMARY

In one embodiment of the invention, a one-way display system has a display layer with opaque active pixels and transparent inactive pixels interspersed with the active pixels. Each active pixel has a chromatic side and an opaque side. The active pixels is able to form an image visible from a first side of the display layer but not from a second side of the display layer, and the inactive pixels allows objects on the first side of the display layer to be seen from the second side of the display layer. When used the one-way display is deployed on a window, it allows a person on the exterior to see the image while a person on the interior is able to look through the window and see the outside without viewing the image, or vice versa.

### BRIEF DESCRIPTION OF THE DRAWINGS

FIGS. 1 and 2 illustrate an one-way display with chromatic and transparent regions in one embodiment of the invention.

FIG. 3 illustrates a display layer of the one-way display using chromatic active pixels and transparent inactive pixels in one embodiment of the invention.

FIG. 4 illustrates a display layer of the one-way display using opaque and transparent substrates in one embodiment of the invention.

FIG. 5 illustrates a one-way display with a polarized light source and a polarizing filter in one embodiment of the invention.

FIG. 6 illustrates a one-way display with a polarized light source, retarders, and polarizing filters in one embodiment of the invention.

FIG. 7 illustrates a one-way display with a liquid crystal display in one embodiment of the invention.

FIG. 8 illustrates a one-way display with a organic light-emitting diode display in one embodiment of the invention.

Use of the same reference numbers in different figures indicates similar or identical elements.

### DETAILED DESCRIPTION

A one-way display is provided that generates a visible image when the display is viewed from one direction. The display provides substantially unobstructed through-viewing when viewed from a second, opposite direction.

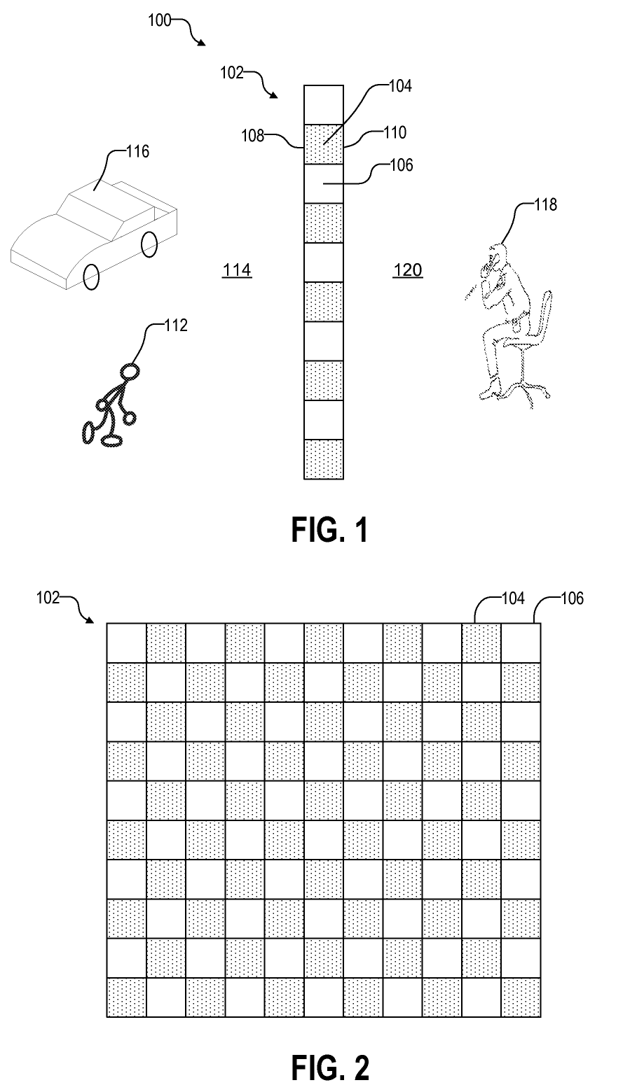

FIG. 1 illustrates a reflective one-way display system 100 in one embodiment of the invention. System 100 includes a flat panel display 102 with chromatic regions 104 and transparent regions 106 (only one of each is labeled for clarity). Each chromatic region 104 has a chromatic side 108 and an opaque side 110. Chromatic regions 104 can be activated by driver circuitry to form a visible image when a person 112 views display 100 from a side 114 (e.g., an exterior side) of system 100. Transparent regions 106 provide substantially unobstructed through-viewing of an object 116 for a person 118 from a side 120 (e.g., an interior side) of system 100.

FIG. 2 illustrates an interspersed pattern of chromatic regions 104 and transparent regions 106 in flat panel display 102 in one embodiment of the invention. Each row and each column consist of alternating chromatic and transparent regions. Other patterns are possible as long as display 100 is able to generate a clear image when viewed from side 114 and substantially unobstructed through-viewing from side 120. Furthermore, chromatic regions 104 and transparent regions 106 may be of any shape, including round and rectangular.

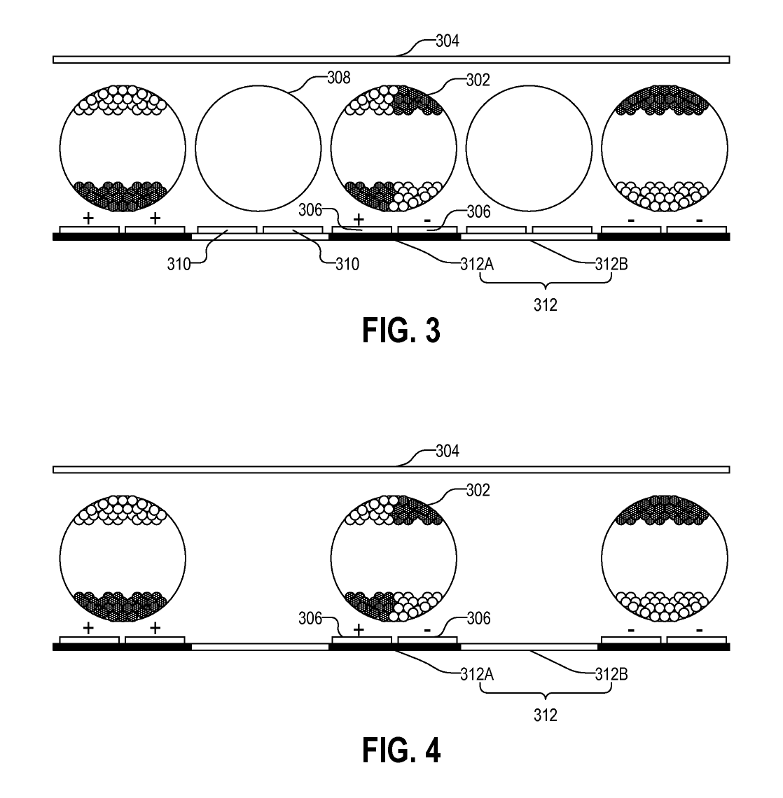

Flat panel display 102 can be implemented with many display technologies, including electronic paper, liquid crystal display (LCD), and organic light-emitting diode (OLED) display. FIG. 3 illustrates flat panel display 102 as an electronic paper display using electrophoretic technology in one embodiment of the invention. In electronic paper display 102, chromatic regions 104 are active microcapsules 302 (only one is labeled for clarity). Each microcapsule 302 is sandwiched between a transparent top electrode 304 and one or more transparent or opaque bottom electrodes 306. Each microcapsule 302 contains oppositely charged chromatic particles of contrasting colors that are controlled by the electric field applied by electrodes 304 and 306 to form part of the image. For example, the charged chromatic particles consist of negatively charged black particles and positively charged white particle, or vice versa. Alternatively, electronic paper display 102 utilizes Gyricon technology where each microcapsule 302 contains chromatic particles consisting of oppositely charged hemispheres of contrasting color. For example, the chromatic particles consist of a negatively charged black hemisphere and a positively charged white hemisphere, or vice versa.

Transparent regions 106 are inactive microcapsules 308 without chromatic particles (only one is labeled for clarity) in one embodiment of the invention. Each microcapsule 308 is sandwiched between transparent top electrode 304 and transparent bottom electrodes 310.

Microcapsules 302 and 308 are mounted on a supporting substrate 312 with opaque areas 312A and transparent areas 312B (only one of each is labeled for clarity). For example, opaque areas 312A and transparent areas 312B are interspersed in a pattern so that microcapsules 302 are located on opaque areas 312A and microcapsules 308 are located on transparent areas 312B. This allows light to pass through microcapsules 308 and transparent areas 312B substantially unobstructed so that person 118 can see object 116 through system 100 as shown in FIG. 1.

FIG. 4 illustrates one embodiment of chromatic regions 104 and transparent region 106. In this embodiment, chromatic regions 104 are microcapsules 302 (only one is labeled for clarity) that are spaced apart, and transparent regions 106 are defined by the spaces between microcapsules 302. Each microcapsule 302 is sandwiched between a transparent top electrode 304 and one or more transparent or opaque bottom electrodes 306. Furthermore, microcapsules 302 are located on opaque areas 312A of supporting substrate 312, and the spaces between microcapsules 302 are located over transparent areas 312B of supporting substrate 312. This allows light to pass through the spaces between microcapsules 302 and transparent areas 312B substantially unobstructed so that person 118 can see object 116 through system 100 as shown in FIG. 1.

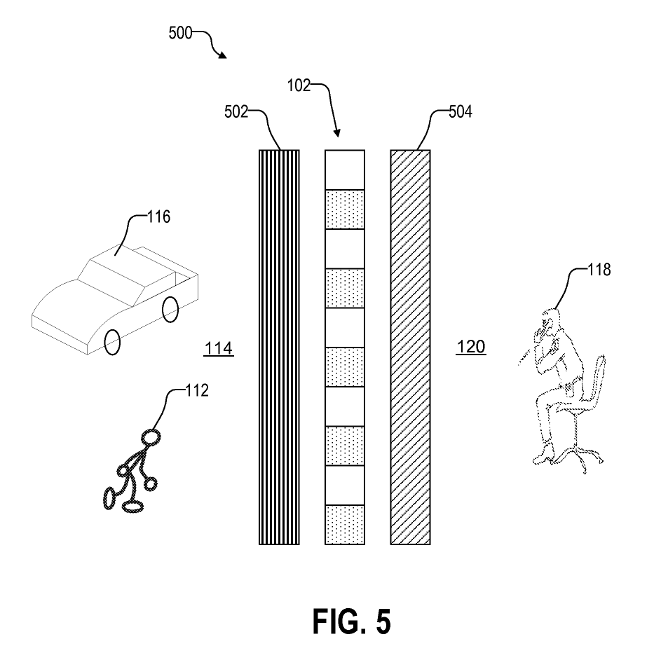

FIG. 5 illustrates a reflective one-way display system 500 in one embodiment of the invention. System 500 is similar to system 100 except it has a light source to help person 112 see the image in low light situations.

System 500 includes flat panel display 102 as described above, a transparent light-emitting layer 502 on side 114 of display layer 102, and a polarizing filter layer 504 on side 120 of flat panel display 102. Light-emitting layer 502 emits a polarized light that is filtered by polarizing filter layer 504.

In use, light-emitting layer 502 illuminates the image formed by the chromatic regions 104 in flat panel display 102. Any polarized light that pass through transparent regions 106 of flat panel display 102 is filtered by polarizing filter layer 504 so it does not disturb person 118 as he looks through system 500.

In one embodiment, light-emitting layer 502 is implemented with transparent organic light-emitting diodes (TOLEDs). In one embodiment, light-emitting layer 502 and polarizing filter layer 504 are mounted to flat panel display 102.

In one embodiment, light-emitting layer 502 can be integrated into flat panel display 102 so that the front surfaces of chromatic regions 104 of flat panel display 102 glow.

In an alternative embodiment, light-emitting layer 502 is replaced with a conventional light source that illuminates the chromatic side of flat panel display 102. If the conventional light source illuminates flat panel display 102 with polarized light, then polarizing filter layer 504 is retained. Alternatively, polarizing filter layer 504 is eliminated when the conventional light source illuminates flat panel display 102 with randomly polarized light.

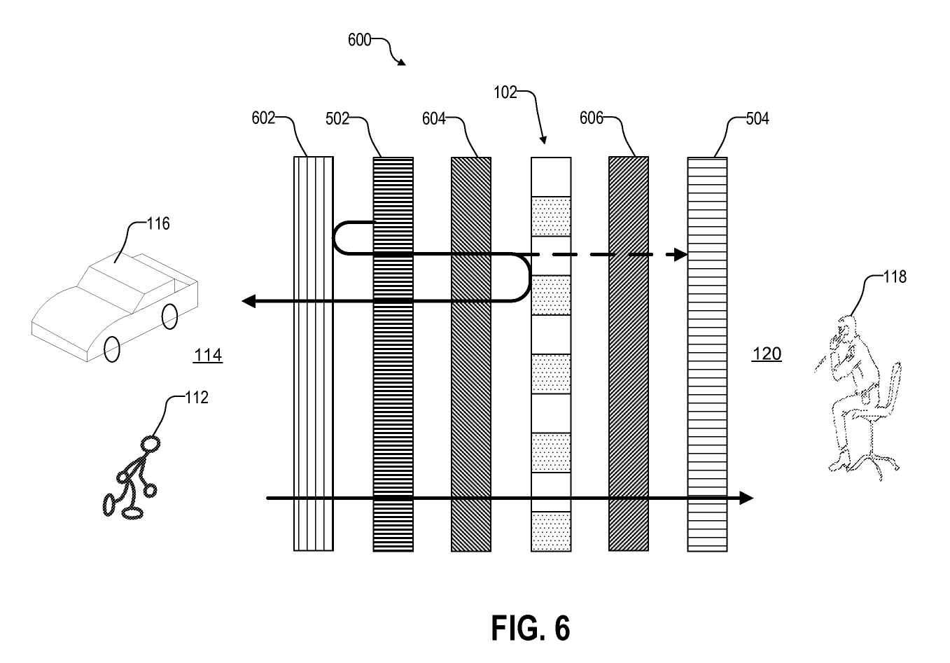

FIG. 6 illustrates a reflective one-way display system 600 in one embodiment of the invention. System 600 is similar to system 500 except it uses a reflecting polarizing filter layer to direct more light onto the chromatic regions in flat panel display 102.

System 600 includes flat panel display 102, transparent light-emitting layer 502, and polarizing filter layer 504 as described above. System 600 further includes a reflecting polarizing filter layer 602 on side 114 of light-emitting layer 502, a first retarder layer 604 between light-emitting layer 502 and flat panel display 102, and a second retarder player 606 between flat panel display 102 and polarizing filter layer 504.

In use, light-emitting layer 502 illuminates the image formed by chromatic regions 104 in flat panel display 102 so person 114 can see the image in low light. Reflecting polarizing filter layer 602 reflects polarized light emitted by transparent light-emitting layer 502. Thus, any polarized light emitted by light-emitting layer 502 that directly impinges polarizing filter layer 602 is reflected back toward flat panel display 102. Polarized light that passes through retarder layer 604, reflects from the chromatic regions in flat panel display 102, and passes again through retarder layer 604 in the opposite direction is able to pass through polarizing filter layer 602. In one embodiment, retarder layer 604 is a quarter-wave plate.

Ambient light that passes through polarizing filter layer 602, retarder layer 604, and retarder layer 606 can pass through polarizing filer layer 504. This allows person 118 to see object 116 through display 600 from side 120. In one embodiment, retarder layer 606 is a quarter-wave plate that rotates the light orientation in the opposite direction as retarder layer 604.

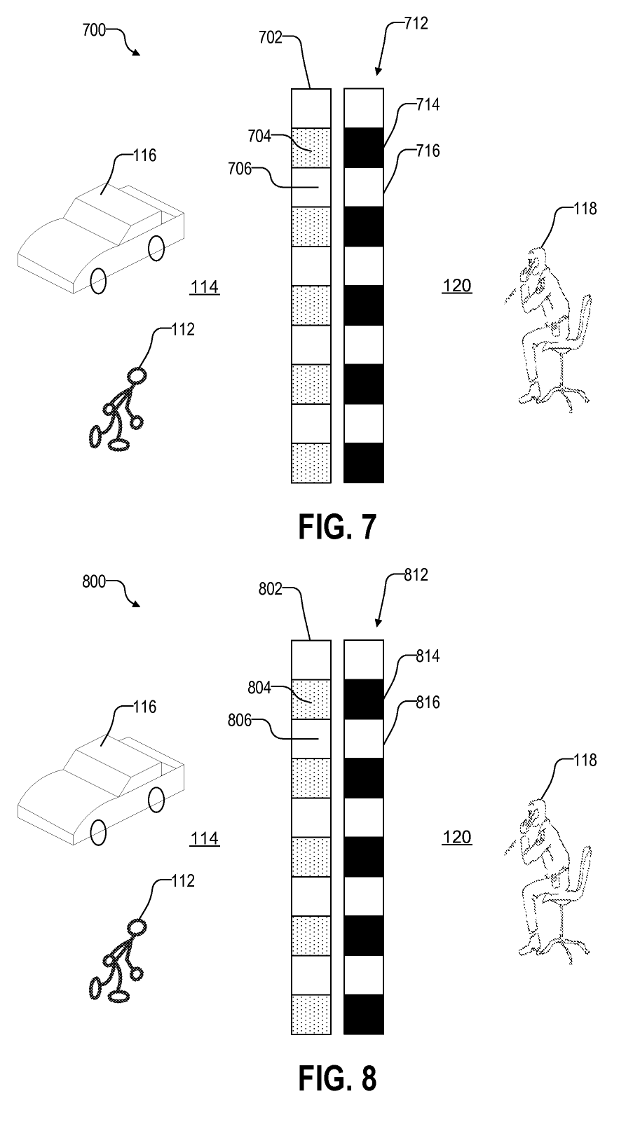

FIG. 7 illustrates an LCD one-way display system 700 in one embodiment of the invention. System 700 includes a flat panel display 702 backlit by a light source 712. In this embodiment, flat display panel 702 is an LCD display. Like flat panel display 102 of FIG. 1, LCD display 702 has chromatic regions 704 and transparent regions 706 (only one of each is labeled for clarity). Chromatic regions 704 consist of active cells with liquid crystal that can be activated by driver circuitry to form a visible image when person 112 views system 700 from side 114 (e.g., an exterior side) of system 700. Transparent regions 706 consist of inactive cells without any liquid crystal.

Light source 712 has opaque regions 714 and transparent regions 716 (only one of each is labeled for clarity) that are interspersed in a pattern so that chromatic regions 704 are located on opaque regions 714 and transparent regions 706 are located on transparent region 716. Together, LCD display 702 and light source 712 allow person 112 to see an image formed by LCD display 702 and backlit by light source 712 from side 114, and person 118 to see object 116 through system 700 from side 120. In one embodiment, light source 712 consists of TOLEDs on a substrate having interspersed transparent and opaque areas (e.g., a checkered substrate).

FIG. 8 illustrates an OLED one-way display system 800 in one embodiment of the invention. System 800 includes a flat panel display 802. In this embodiment, flat display panel 802 is an OLED display. Like flat panel display 102 of FIG. 1, OLED display 802 has chromatic regions 804 and transparent regions 806 (only one of each is labeled for clarity). Chromatic regions 804 consist of active cells with OLED that can be activated by driver circuitry to form a visible image when person 112 views system 800 from side 114 (e.g., an exterior side) of system 800. Transparent regions 806 consist of inactive cells without any OLED.

If OLED display 802 emits light on both sides, then system 800 includes a supporting substrate 812 with opaque regions 814 and transparent regions 816 (only one of each is labeled for clarity) that are interspersed in a pattern so that chromatic regions 804 are located on opaque regions 814 and transparent regions 806 are located on transparent region 816. Together, OLED display 802 and substrate 812 allow person 112 to see an image formed by OLED display 802 from side 114, and person 118 to see object 116 through system 800 from side 120. In one embodiment, substrate 812 is a transparent material painted with a pattern that forms opaque regions 814 and transparent regions 816.

Various other adaptations and combinations of features of the embodiments disclosed are within the scope of the invention. Numerous embodiments are encompassed by the following claims.

What is claimed is:

1. A one-way display system, comprising:
chromatic regions each comprising (1) a chromatic side viewed from a first side of the display system and (2) an opaque side viewed from a second side of the display system;
transparent regions allowing objects on the first side of the display system to be seen from the second side of the display system; and
driver circuitry for activating the chromatic regions to form an image visible from the first side of the display system but not from the second side of the display system.

2. The system of claim 1, wherein
the chromatic regions comprise active pixels; and
the transparent regions comprise transparent inactive pixels interspersed with the active pixels.

3. The system of claim 2, wherein the active pixels comprise electronic paper microcapsules with charged chromatic particles located between electrode layers.

4. The system of claim 3, wherein the electronic paper microcapsules with charged chromatic particles are located on opaque areas of a supporting substrate.

5. The system of claim 4, wherein the inactive pixels comprise electronic paper microcapsules without charged chromatic particles located on transparent areas of the supporting substrate.

6. The system of claim 4, wherein the transparent regions are spaces between the electronic paper microcapsules with charged chromatic particles above transparent areas of the supporting substrate.

7. The system of claim 2, wherein each row and each column of the display system comprise alternating active and inactive pixels.

8. The system of claim 1, further comprising a light source illuminating chromatic sides of the chromatic regions.

9. The system of claim 1, wherein the active pixels and the inactive pixels form a display layer, the system further comprising:
a polarizing filter layer on the second side of the display layer, the polarizing filter layer filtering a polarized light illuminating the image from the first side of the display layer.

10. The system of claim 9, further comprising:
a transparent light-emitting layer on the first side of the display layer, the transparent light-emitting layer emitting the polarized light.

11. The system of claim 10, wherein the transparent light-emitting layer comprises transparent organic light-emitting diodes.

12. The system of claim 9, further comprising a polarizing light source illuminating chromatic sides of the chromatic regions.

13. The system of claim 2, wherein the active pixels and the inactive pixels form a display layer, the system further comprising:
a first retarder layer on the first side of the display layer;
a transparent light-emitting layer on the first side of the first retarder layer, the transparent light-emitting layer emitting polarized light; and
a reflective polarizing filter layer on the first side of the transparent light-emitting layer, wherein the reflective polarizing filter layer:
reflects the polarized light as originally emitted by the transparent light-emitting layer; and
passes the polarized light that passes through the first retarder layer, reflects from the display layer, passes again through the first retarder layer and onto the reflective polarizing filter layer.

14. The system of claim 13, further comprising:
a second retarder layer on the second side of the display layer; and
a polarizing filter layer on the second side of the second retarder layer, wherein the polarizing filter layer:
blocks the polarized light that passes through the first retarder layer, the display layer, the second retarder layer and onto the polarizing filter layer;
passes the ambient light that passes through the first retarder layer, the display layer, the second retarder layer and onto the polarizing filter layer.

15. The system of claim 1, wherein:
the chromatic regions comprises cells of liquid crystal in an liquid crystal display (LCD) display over opaque areas of a backlight; and
the transparent regions comprises cells without liquid crystal in the LCD display over transparent areas of the backlight.

16. The system of claim 15, wherein the backlight comprises transparent organic light-emitting diodes having a supporting substrate with the opaque and the transparent areas.

17. The system of claim 1, wherein:
the chromatic regions comprises cells of organic light-emitting diode (OLED) in an OLED display over opaque areas of a substrate; and
the transparent regions comprises cells without OLED in the OLED display over transparent areas of the substrate.

18. The system of claim 1, wherein the substrate comprises a transparent material painted with a pattern of the transparent and the opaque areas.
